(19) United States
(12) Patent Application Publication
(10) Pub. No.: US 2008/0237996 A1
(43) Pub. Date: Oct. 2, 2008

(54) Rotary leadthrough, especially for a torsional vibration damper in a drive train of a vehicle

(75) Inventors: Thomas Busold, Fulda (DE); Thomas Dogel, Bad Kissingen (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/075,553

(22) Filed: Mar. 12, 2008

(30) Foreign Application Priority Data
Mar. 31, 2007 (DE) 10 2007 015 640.7

(51) Int. Cl. F16J 15/34

(52) U.S. Cl. 277/400

(57) ABSTRACT

A rotary lead-through includes a first rotary lead-through element having a first channel opening on a first boundary surface, and a second rotary lead-through element having a second channel opening on a second boundary surface which opposite from the first boundary surface and can rotate relative to the first boundary surface about an axis of rotation, the first and second channels being in fluid communication via a channel boundary space. A sealing arrangement acting between the first and second lead-through elements includes at least one sealing stage, each sealing stage including a first sealing element toward the boundary space and a second sealing element away from the boundary space, the first and second sealing elements enclosing a backpressure chamber surrounding the axis of rotation. Where successive sealing stages are provided, a pressure-limiting valve can be provided in parallel to the seal separating immediately successive backpressure spaces.

### BACKGROUND OF THE INVENTION

1. Field of the Invention

The present invention pertains to a rotary leadthrough of the type which can be used especially to supply a pressurized fluid to a torsional vibration damper in a drive train of a vehicle and to carry it away again.

2. Description of the Related Art

So that torsional vibrations in the drive trains of vehicles can be damped, so-called torsional vibration dampers are used. These can be in the form of dual-mass flywheels, for example, where a primary side and a secondary side can rotate with respect to each other against the action of a damping spring arrangement. The stiffness of the springs of the damping element arrangement has a significant influence on the vibration-damping characteristic. In general, helical compression springs are used for this purpose, the stiffness of which is predetermined by the mechanical layout and/or which can be influenced by their positioning in the torsional vibration damper.

In the case of so-called gas spring torsional vibration dampers, the damping spring arrangement comprises a volume of a compressible medium, usually a volume of gas, which can be compressed when rotational irregularities occur or when torques are to be transmitted. With systems of this type, much higher energy densities can be achieved than are possible with conventional helical compression springs, which means that larger rotational irregularities can also be compensated. By varying the compression of the compressible medium, that is, of the gas, it is also possible to influence the spring stiffness and thus the damping characteristic. For this purpose, a liquid medium is generally used, which is separated by a separating piston or the like from the compressible gaseous medium. Changing the pressure of this liquid medium has the effect of changing the compression state of the gas and therefore the damping characteristic as well.

Because these torsional vibration dampers working with compressible media are usually rotating systems, it is necessary for the liquid medium, used in particular to influence the damping characteristic, to be conducted via a rotary leadthrough into the area of the torsional vibration damper and to conduct it away from that area again. This type of rotary leadthrough can be realized, for example, by two components concentric to each other, the first, outer leadthrough element being stationary, whereas the second, inner leadthrough element in the form of a shaft rotates along with the torsional vibration damper. A fluid channel arrangement is formed in the two rotary leadthrough elements, sections of the arrangement passing through both the first and the second element. In an area adjacent to the channels, these channel areas are open to the associated surfaces of the rotary leadthrough elements and are thus in fluid-exchange connection with each other via a channel boundary space formed between the two rotary leadthrough elements. On the two axial sides, this channel boundary space is closed off by the sealing elements of a sealing arrangement to prevent as effectively as possible the escape of fluid from this area adjacent to the channels.

Because these types of sealing elements do not generally guarantee a completely leak-tight closure of the channel boundary space at the very high pressures of up to 70 bars to be expected, it is known, for example, that a fluid discharge space can be formed on the side of these sealing elements facing away from the channel boundary space; this discharge space is closed off by another sealing element and is open to an essentially pressureless fluid reservoir by way of a discharge channel arrangement. This means that fluid which has managed to pass through the sealing elements closing off the channel boundary space arrives in the fluid discharge space and, because this fluid discharge space is essentially pressureless, the sealing element which follows next is not subjected to any pressure. Thus it can be guaranteed that all of fluid arriving in the fluid discharge space can also be returned via the discharge channel arrangement to the reservoir.

A problem with these types of rotary leadthroughs has to do with the sealing elements which form the boundaries of the fluid discharge space. That is, the sides of these elements which face the area adjacent to the channels must absorb all of the pressure over the entire range of pressure loads which can occur. In the case of rotary leadthroughs for torsional vibration dampers in drive trains, this pressure usually does not exceed a value of 20 bars in the normal working range. If, however, comparatively severe torsional vibrations occur, the liquid medium will also obviously be subjected to a corresponding pressure, and this pressure will also act on the sealing elements forming the boundaries of the channel boundary space. This can lead to excessive leakage of fluid and especially to damage to the sealing elements.

### SUMMARY OF THE INVENTION

An object of the present invention is to provide a rotary leadthrough, especially for a torsional vibration damper in a drive train of a vehicle, by means of which a leakproof seal against very high pressures can be reliably achieved.

According to the invention, this object is achieved by a rotary leadthrough for conducting fluid through the boundary area between two rotary leadthrough elements which are able to rotate relative to each other around an axis of rotation. A first rotary leadthrough element has a first rotary leadthrough element surface and a second rotary leadthrough element has a second rotary leadthrough element surface opposite the first rotary leadthrough element surface, the second surface being able to rotate around the axis of rotation relative to the first surface. A fluid channel arrangement with a first channel area in the first rotary leadthrough element and with a second channel area in the second rotary leadthrough element is provided, where the first channel area and the second channel area are in fluid-exchanging connection with each other in an area adjacent to the channels, and a sealing arrangement acts between the first rotary leadthrough element and the second rotary leadthrough element.

It is also provided that the sealing arrangement includes at least one sealing stage with a backpressure chamber, the boundaries of which are formed by a sealing element closer to the area adjacent to the channels and a sealing element farther away from the area adjacent to the channels.

In the inventive rotary leadthrough, the sealing arrangement therefore forms at least one sealing stage with a backpressure chamber bounded by two sealing elements. The fluid also present in the boundary area between the two rotary leadthrough elements will collect in this backpressure chamber as a result of, for example, the leakage usually present in the area of the sealing elements and will build up a backpressure there, which acts on the rear surface of the sealing element closer to the area adjacent to the channels. Because of this backpressure, not only the side of this sealing element facing the area adjacent to the channels but also its rear side is subjected to load, so that, even at comparatively high pressures, the existing pressure difference means that the sealing element will be subjected to a much lighter load than it would be if there were no backpressure of this type at all. The reason that this backpressure can build up in the inventive rotary leadthrough is that the backpressure chamber in question is bounded by sealing elements and is not connected to a discharge channel arrangement or the like which can carry away the fluid which collects there. In short, it is not kept in a pressureless state.

In an especially advantageous elaboration of the inventive rotary leadthrough, it is proposed that a plurality of successive sealing stages, each with its own backpressure chamber, be provided in sequence in the direction proceeding away from the area adjacent to the channels. The backpressure chambers of two adjacent sealing stages are separated by a sealing element, which, in the case of the sealing stage closer to the area adjacent to the channels, forms the sealing element farther away from the area adjacent to the channels, and, in the case of the sealing stage farther away from the area adjacent to the channels, forms the sealing element closer to the area adjacent to the channels. In this arrangement, therefore, a cascade of sealing stages is created, so that, in the direction proceeding away from the area adjacent to the channels, a stepwise decrease in the pressure acting on the sealing elements in question and also in the backpressure supporting these sealing elements is achieved.

In a variant which is especially advantageous when the rotary leadthrough is combined with a torsional vibration damper in a drive train of a vehicle, the first rotary leadthrough element surface be an inside circumferential surface of the first rotary leadthrough element, this surface being essentially coaxial to the axis of rotation, and the second rotary leadthrough element surface is an outside circumferential surface of the second rotary leadthrough element, this surface being essentially coaxial to the axis of rotation and to the first rotary leadthrough element surface.

Alternatively, of course, it is also possible for the first rotary leadthrough element surface and the second rotary leadthrough element surface to be essentially at right angles to the axis of rotation and to be axially opposite each other.

The sealing elements can be designed in the form of rings, which fit into ring-shaped grooves in the first rotary leadthrough element and/or in the second rotary leadthrough element and which rest against the rotary leadthrough element surface of the other rotary leadthrough element, that is, of the rotary leadthrough element in which no groove for a sealing element is provided.

As previously explained, these types of sealing elements are usually designed in such a way that they have or allow a certain leakage, that is, a leakage stream of the fluid to which they are exposed. These sealing elements, which therefore form the boundaries of a backpressure space, thus also have essentially the functionality of a pressure-limiting valve or throttle point. So that excessive loads on these sealing elements can be prevented more effectively, especially under strong pressures, and/or so that defined pressure relationships can be achieved, it is possible to connect at least two immediately successive spaces together by means of a pressure-limiting valve, which acts in parallel with the sealing element which separates these spaces. A pressure-limiting valve of this type therefore has the functionality of producing defined pressure relationships in the two spaces to be connected together by it, relationships such that, for example, a certain maximum pressure difference cannot be exceeded.

Especially in the case of rotary leadthrough element surfaces which are concentric to each other, it is necessary to close off the area adjacent to the channels in both axial seals. It can also be necessary to provide a closing-off of this type in both radial directions in the case of axially opposing rotary leadthrough element surfaces. It is therefore proposed that at least one sealing stage be provided on each side of the area adjacent to the channels, and that the backpressure spaces of corresponding sealing stages, i.e., the backpressure spaces on one side of the area adjacent to the channels and the corresponding backpressure spaces on the other side of that area, be connected by connecting channel arrangements to create pairs of interconnected backpressure spaces. By connecting the backpressure spaces of the corresponding sealing stages on the two sides of the area adjacent to the channels, it is ensured that the pressure in these backpressure spaces which have been formed into pairs and connected to each other will always be essentially the same. Thus the buildup of pressure differences between the two sides of the area adjacent to the channels is avoided.

So that a defined step-down of the pressure in the sealing stages following each other in the direction proceeding away from the channel boundary area can be achieved in this arrangement as well, the pairs of backpressure chambers of immediately successive sealing stages can be connected to each other by pressure-limiting valves.

The connecting channel arrangements of the different pairs of backpressure chambers can be located in various circumferential areas relative to the axis of rotation. In this way, it is achieved that at least some of the fluid flowing via the connecting channel arrangements must flow through the backpressure spaces thus connected, which creates a cooling effect. In addition, the spatial separation of these connecting channel arrangements also makes it easier to fabricate the rotary leadthrough elements.

In accordance with another advantageous aspect, the backpressure space of the first sealing stage immediately following the area adjacent to the channels is connected to the channel boundary space of the area adjacent to the channels by a pressure limiting valve. It can be ensured in this way that even the first sealing element following the area adjacent to the channels can be relieved of load in a defined manner by the pressure-limiting valve assigned to it and/or acting in parallel with it.

A pressure-limiting valve can also be assigned to the backpressure space of the sealing stage in last place in the direction proceeding away from the area adjacent to the channels, so that this backpressure space can be connected to a fluid discharge space downstream from it. A discharge channel arrangement for carrying fluid away from the fluid discharge space can be assigned to the discharge space. It should be pointed out here that, of course, if only a single sealing stage is provided, a discharge space of this type can follow after the single sealing stage and/or its backpressure space.

The discharge channel arrangement can lead to an essentially pressureless fluid reservoir. In this way, it is ensured that no pressure can build up in the fluid discharge space. Thus there will be essentially no pressure acting on the sealing element closing off this fluid discharge space on the side facing away from the area adjacent to the channels, and the sealing element will completely prevent the leakage of fluid.

To ensure that the sealing elements cannot be damaged by excessive loads, the pressure-limiting valve should have a pressure-limiting characteristic such that the maximum possible pressure difference in the spaces to be connected by it is smaller than the maximum allowable pressure load on the sealing element which separates these two spaces.

So that a uniform step-down of the fluid pressure can be achieved, especially in the case of a cascade-like arrangement of sealing stages, the pressure-limiting valves connecting/separating immediately successive spaces should be designed in such a way that the maximum possible pressure differences between immediately successive pressure spaces are essentially the same. The pressure-limiting valves can be designed with essentially the same switching pressure and thus open when a pressure difference has built up which exceeds the defined difference, or they can be designed as proportional valves, so that, regardless of how high the pressure at the entrance to one of these pressure-limiting valves is, an exit pressure on the exit side which is in a defined proportional relationship to the entrance pressure will always be produced.

So that an essentially uniform step-down of the pressures in successive backpressure chambers can also be achieved when proportional valves are used, it is proposed that each pressure-limiting valve have a defined proportionality factor, formed as the quotient of the exit pressure divided by the entrance pressure, and that the proportionality factors of the pressure-limiting valves decrease in the direction proceeding away from the area adjacent to the channels.

The present invention also pertains to a combination of a torsional vibration damper arrangement with a primary side and a secondary side and with a damper arrangement, which connects the primary side to the secondary side and which holds a compressible medium; and an inventive rotary leadthrough.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a longitudinal cross section through an inventive rotary leadthrough, illustrating the principles of the invention in schematic fashion;

FIG. 2 shows a diagram, corresponding to FIG. 1, of an alternative embodiment;

FIG. 3 shows a diagram, corresponding to FIG. 1, of an alternative embodiment;

FIG. 4 shows a diagram, corresponding to FIG. 1, of an alternative embodiment; and

FIG. 5 shows another diagram of a rotary leadthrough with radially spaced sealing elements.

### DETAILED DESCRIPTION OF THE PRESENTLY PREFERRED EMBODIMENTS

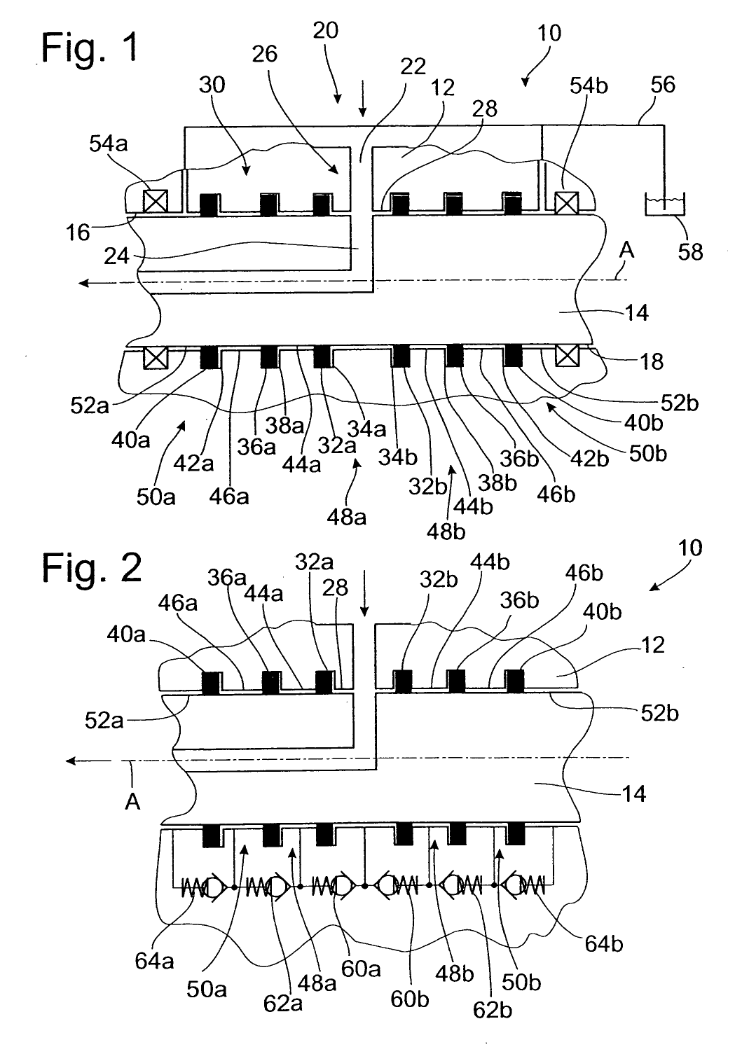

FIG. 1 shows a schematic longitudinal cross section of a rotary leadthrough 10, through which a fluid, especially a pressurized liquid, can be transferred from a stationary first rotary leadthrough element 12 to a second rotary leadthrough element 14, which rotates around an axis of rotation A. It can be seen that the first rotary leadthrough element 12 has a first rotary leadthrough element surface 16, which is essentially coaxial to the axis of rotation A and which surrounds it cylindrically; this surface therefore forms an inside circumferential surface. Concentric to the surface 16 is an outside circumferential surface of the second rotary leadthrough element 14, providing a second rotary leadthrough element surface 18. This second rotary leadthrough element surface is also formed with an essentially cylindrical contour.

Fluid can be transferred via a fluid channel arrangement 20 from the first rotary leadthrough element 12 to the second rotary leadthrough element 14, and fluid can obviously also be conducted from the second rotary leadthrough element 14 back to the first rotary leadthrough element 12. The fluid channel arrangement 20 comprises a first channel area 22 in the first rotary leadthrough element 12, which here, for example, can include one or more channels, which is/are open to the first rotary leadthrough element surface 16. A second channel area 24 in the second rotary leadthrough element 14 has a section open to the second rotary leadthrough element surface 18. The two channel areas 22, 24 open out in approximately the same axial area of the two rotary leadthrough elements 12, 14, as illustrated in FIG. 1. An area 26 adjacent to the channels is therefore formed, in which the two channel areas 22, 24 are in fluid-exchanging connection with each other by way of a channel boundary space 28, which is formed between the two rotary leadthrough elements 12, 14 and which surrounds the axis of rotation A in a ring-like manner.

To prevent the escape of fluid from the area 26 adjacent to the channels and/or from the intermediate space between the two rotary leadthrough elements 12, 14, a sealing arrangement 30 having a plurality of sealing elements, is provided.

It can be seen in FIG. 1 that two ring-shaped sealing elements 32a, 32b form the boundaries of the channel boundary space 28; one of these sealing elements is on each side of the channel areas 22, 24, that is, in the present case, on each axial side of the area 26 adjacent to the channels. These sealing elements 32a, 32b fit into grooves 34a, 34b in the inside circumference of the first rotary leadthrough element 12 and rest on the second rotary leadthrough element surface 18 of the second sealing element 14. Somewhat farther away from the area 26 adjacent to the channels and a certain axial distance away from the sealing elements 32a, 32b are additional ring-like sealing elements 36a, 36b, which are also held in circumferential grooves 38a, 38b in the first rotary leadthrough element 12 and which also rest on the second rotary leadthrough element surface 18 of the second rotary leadthrough element 14. Still farther away from the area 26 adjacent to the channels are additional ring-like sealing elements 40a, 40b, again held in circumferential grooves 42a, 42b in the inside circumference of the first rotary leadthrough element 12 and again resting with a sealing action on the second rotary leadthrough element surface 18 of the second rotary leadthrough element 14.

A backpressure space 44a, 44b is formed in each case between the sealing elements 32a, 32b, which form the immediate boundaries of the channel boundary space 28 in the direction proceeding away from the area 26 adjacent to the channels, and the sealing elements 36a, 36b, which are farther away in the direction proceeding away from the area 26 adjacent to the channels. The boundaries of the backpressure spaces 44a, 44b are therefore formed by their associated sealing elements 32a, 36a in the one case and 32b, 36b in the other case and by the sections, enclosed between sealing elements, of the first rotary leadthrough element surface 16 and the second rotary leadthrough element surface 18.

Backpressure spaces 46a, 46b are also formed between the sealing elements 36a, 36b and the sealing elements 40a, 40b following after them in the direction proceeding away from the area 26 adjacent to the channels. The boundaries of these backpressure spaces are again formed by their associated sealing elements 36a, 40a in the one case and 36b, 40b in the other and by the sections of the rotary leadthrough element surfaces 16 and 18 enclosed between the sealing elements.

The series of sealing elements and backpressure spaces formed between pairs of sealing elements creates a cascade-like arrangement of sealing stages as described above and illustrated in FIG. 1. Thus the sealing elements 32a, 36a and 32b, 36b, in cooperation with the associated backpressure spaces 44a, 44b situated between them, create first sealing stages 48a, 48b. The sealing elements 36a, 40a in the one case and 36b, 40b in the other, cooperating with the backpressure spaces 46a, 46b situated between them, form second sealing stages 50a, 50b. In each case the sealing elements 36a, 36b form both sealing elements of the first sealing stages 48a, 48b and sealing elements of the second sealing stages 50a, 50b.

Following the second sealing stages 50a, 50b, and therefore in last place in the direction proceeding away from the area 26 adjacent to the channels 22, 24, fluid discharge spaces 52a, 52b are formed between the rotary leadthrough element surfaces 16 and 18. In their terminal areas farther away from the area 26 adjacent to the channels, the fluid discharge spaces 52a, 52b are bounded by sealing elements 54a, 54b. Each of the fluid discharge spaces 52a, 52b is connected by a fluid discharge channel arrangement 56 formed essentially in the first rotary leadthrough element 12 to a reservoir 58 for the fluid to be transferred via the rotary leadthrough 10. This fluid reservoir 58 is essentially pressureless, so that the discharge channel arrangement 56 and the fluid discharge spaces 52a, 52b are also pressureless.

When the fluid, usually a liquid, which is to be transferred via the rotary leadthrough 10 is under a comparatively high pressure of, for example, as much as 70 bars, this high pressure is present essentially in the channel boundary space 28, and thus a corresponding load is exerted on the first sealing elements 32a, 32b of the first sealing stages 48a, 48b following this channel boundary space 28. As explained above, the sealing elements 32a, 32b, 36a, 36b, 40a, 40b assigned to the various sealing stages 48a, 48b and 50a, 50b are designed in such a way that, although they are basically leak-tight when subjected to pressure, they also allow or can be forced to allow a certain amount of fluid leakage. This means that, when the pressure builds up in the channel boundary space 28 as a result of the pressure difference present between the channel boundary space 28 and the backpressure spaces 44a, 44b of the first sealing stages 48a, 48b, fluid will also arrive in these backpressure spaces 44a, 44b. A backpressure will therefore build up in these backpressure spaces 44a, 44b until a limit pressure difference is reached. This backpressure supports the sealing elements 32a, 32b on the side facing away from the area 26a adjacent to the channels, so that the one-sided load acting on these sealing elements as a result of the pressure in the channel boundary space 28 is reduced.

If the pressure in the backpressure spaces 44a, 44b of the first sealing stages 48a, 48b is high enough, a corresponding process will also take place in the transition between the two sealing stages 48a, 48b and 50a, 50b. That is, fluid will also pass as a leakage stream beyond the sealing elements 36a, 36b and arrive in the backpressure spaces 46a, 46b of the second sealing stages 50a, 50b, and this will continue until a certain pressure difference is built up between the backpressure spaces 44a, 46a and 44b, 46b. The result of this pressure buildup is that the two sealing elements 36a, 36b separating the sealing stages 48a, 50a and 48b, 50b are also subjected to load on only one side by a force which is determined by the pressure difference between the two backpressure spaces 44a, 46a and 44b, 46b.

Because the sealing elements 40a, 40b of the second sealing stages 50a, 50b coming last in the direction proceeding away from the area 26 will also allow a certain leakage stream when, for example, a certain fluid pressure is reached in the backpressure spaces 46a, 46b, fluid will also arrive in the fluid discharge spaces 52a, 52b. In contrast to the backpressure spaces 44a, 46a; 44b, 46b, these fluid discharge spaces 52a, 52b are not closed off but are rather open via the discharge channel arrangement 56 and are thus kept pressureless. The fluid which has arrived in the fluid discharge spaces 52a, 52b can therefore flow back to the reservoir 58 and can be returned to the circuit again without exerting any significant load on the sealing elements 54a, 54b the farthest away from the area 26 adjacent to the channels. With the design of a rotary leadthrough as described above, according to which the pressure acting on the sealing elements is reduced from one sealing stage to the next over the course of the entire sequence of individual sealing stages, and according to which the sealing elements are supported in the opposing direction, it is possible for the leadthrough to absorb even very high pressures, including those which occur, for example, when a torsional vibration damper equipped with gas springs is used in the drive train of a motor vehicle.

A modified embodiment of the rotary leadthrough 10 is described below with reference to FIG. 2. This corresponds in many respects to the previously described embodiment, especially with respect to the arrangement of the sealing elements or sealing stages, so that reference can be made to the previous explanations. It should also be pointed out that the fluid discharge spaces and the associated assemblies are not shown again in FIG. 2 or in the following figures, but it should be obvious that they are nevertheless present here or could be present here.

It can be seen in FIG. 2 that a pressure-limiting valve 60a, 62a, 64a; 60b, 62b, 64b is provided for each of the sealing elements 32a, 36a, 40a; 32b, 36b, 40b, which form or limit the sealing stages 48a, 50a; 48b, 50b lying on both sides of the channel boundary space 28. The two pressure-limiting valves 60a, 60b, which can open or close the connection between the channel boundary space 28 and the backpressure spaces 44a, 44b of the first sealing stages 48a, 48b, are located in connecting channels, which establish a connection between the channel boundary space 28 and the backpressure spaces 44a, 44b. The pressure-limiting valves 62a, 62b are installed in connecting channels, which establish a connection between the backpressure spaces 44a, 44b and the respective backpressure spaces 46a, 46b. The pressure-limiting valves 64a, 64b are provided in connecting channels, which establish a connection between the backpressure spaces 46a, 46b and the fluid discharge spaces 52a, 52b which follow them. The pressure-limiting valves 60a, 62a, 64a; 60b, 62b, 64b can be designed as spring-loaded check valves, for example, and they can also be designed so that they have the same pressure-switching characteristics, that is, so that they open at the same pressure on the higher-pressure side, that is, the entrance side, or at the corresponding pressure differences between the entrance side and the lower-pressure side, that is, the exit side. This means that a pressure-limiting valve 60a, 62a, 64a; 60b, 62b, 64b is connected in parallel to each of the sealing elements 32a, 36a, 40a; 32b, 36b, 40b defining the sealing stages 48a, 50a; 48b, 50b. Under appropriate pressure relationships, therefore, there will be a leakage stream passing via the associated sealing elements, and in addition the pressure-limiting valves will open under the corresponding pressures, with the result that defined pressure differences corresponding to the switching characteristics, that is, to the switching pressures of the valves of this type, will develop between the spaces now connected by the open pressure-limiting valves. If, for example, the pressure-limiting valves 60a, 62a, 64a; 60b, 62b, 64b are designed in such a way that they open at a switching pressure of 20 bars and if, furthermore, the pressure prevailing in the channel boundary space 28 is approximately 60 bars, then all of the pressure-limiting valves will open, with the result that a pressure of approximately 40 bars will be present in the first backpressure spaces 44a, 44b, and a pressure of approximately 20 bars will be present in the second backpressure spaces 46a, 46b. The result of this is that each of the sealing elements 32a, 36a, 40a, 32b, 36b, 40b will be subjected to a net pressure of approximately 20 bars on the higher-pressure side, that is, on the side facing the channel boundary space 28, which means that excessive pressure loads can be avoided, especially those on the sealing elements forming the immediate boundaries of the channel boundary space 28. If the pressure in the channel boundary space 28 is only slightly above 20 bars, then only the pressure-limiting valves 60a, 60b will open, so that the pressure in the backpressure spaces 44a, 44b will be reduced in correspondence with the switching pressure of 20 bars. The following pressure-limiting valves 62a, 62b and obviously the other pressure-limiting valves 64a, 64b will not open.

It should be pointed out that here, in place of the pressure-limiting valves, it would also obviously be possible to use other pressure-reducing components such as throttles or diaphragms, which can exercise the desired type of pressure-reducing functionality especially in dynamic states.

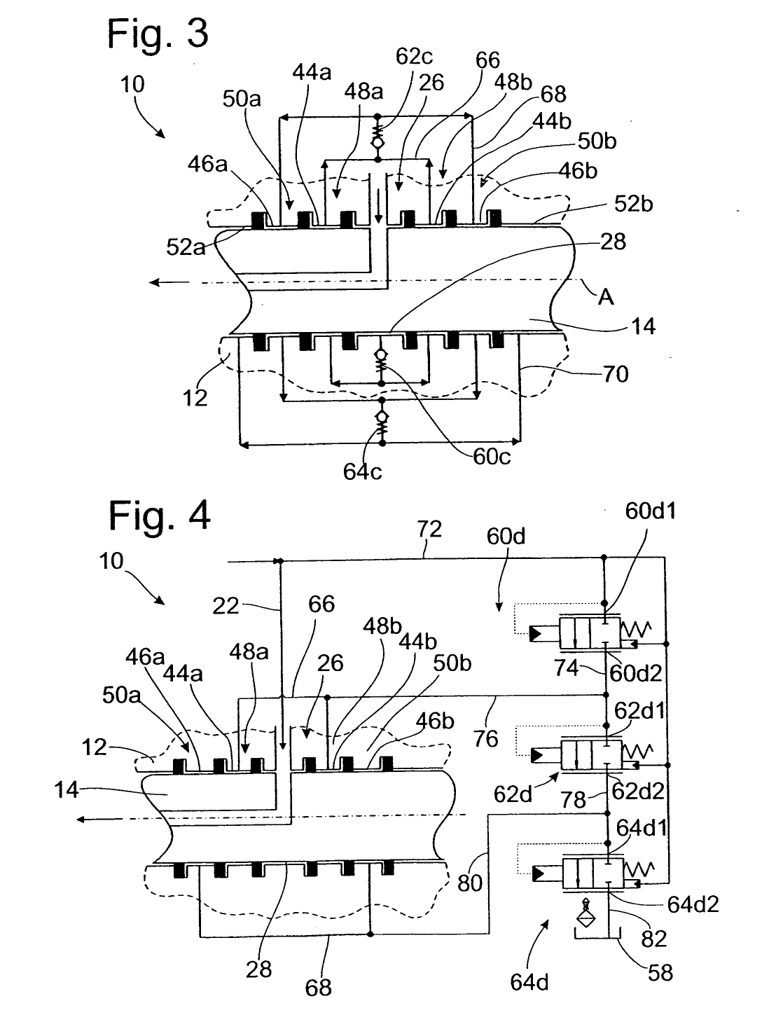

FIG. 3 shows another variant. Here, too, the basic structure with respect to the design and arrangement of the sealing stages is the same as that described on the basis of FIG. 1.

It can be seen that, in this embodiment, the backpressure spaces of corresponding sealing stages, i.e., the backpressure spaces of the series of stages on one side of the area 26 adjacent to the channels and the corresponding spaces on the other side, are combined into pairs of backpressure spaces, i.e., are connected to each other by connecting channel arrangements 66, 68. In the same way, a connecting channel arrangement 70 connects the two fluid-discharge spaces 52a, 52b to each other. As a result of these connecting channel arrangements 66, 68, it will always be possible for the pressure to equalize between the backpressure spaces 44a and 44b of the associated first sealing stages 48a and 48b, and correspondingly it will also be possible for the pressure to equalize between the backpressure spaces 46a, 46b of the associated second sealing stages 50a, 50b. This guarantees that the sequence of loads proceeding in one direction away from the channel boundary area will be the same as that proceeding in the other direction.

It is also possible to see in FIG. 3 that, under appropriate pressure relationships, a pressure-limiting valve 62c can establish a connection between the backpressure spaces 44a, 44b of the first sealing stages 48a, 48b and the backpressure spaces 46a, 46b of the second sealing stages 50a, 50b. In the same way, a pressure-limiting valve 60c can establish a connection between the channel boundary space 28 and the backpressure spaces 44a and 44b of the first sealing stages 48a, 48b, whereas a pressure-limiting valve 64c establishes a connection between the backpressure spaces 46a, 46b of the second sealing stages 50a, 50b and the following fluid discharge spaces 52a, 52b.

Here again, the pressure-limiting valves 60c, 62c, and 64c are designed with basically the same switching characteristic, so that a functionality is obtained which is similar to that described above with reference to FIG. 2. In addition, however, it is guaranteed here that the same pressure relationships will be present in the pressure-limiting spaces which have been assigned to each other in pairs and connected to each other by the connecting channel arrangements.

It can be seen in FIG. 3 that the pressure-limiting valves can also be located in different circumferential areas with respect to the axis of rotation, which obviously means that the connecting channel arrangements in which the pressure-limiting valves act lie in different circumferential areas. In this way, it is possible to create a forced flow through the various backpressure spaces when the pressure-limiting valves are open and fluid can flow through them. This can lead to an additional cooling effect. For example, with the arrangement shown here with two sealing stages, an offset of 180° between pressure-limiting valves 60c and 62c can be provided. The pressure-limiting valve 64c leading to the fluid discharge spaces can then be arranged with another angular offset of 180°. Basically, the three pressure-limiting valves shown here could also be spaced 120° apart from each other. The arrangement shown in FIG. 3, however, offers the possibility of accommodating the two pressure-limiting valves 60c and 64c located in the same circumferential area in the same bore, which obviously would have to be provided with a plug element in the area between the two valves to prevent a connection from existing between them.

Another embodiment of an inventive rotary leadthrough is shown in FIG. 4. Here, too, the basic design, especially in the area of the rotary leadthrough elements 12, 14 and the sealing elements forming the boundaries of the associated sealing stages, is the same as that described on the basis of FIG. 1. In the embodiment according to FIG. 4 as well, it can be seen that, by means of the connecting channel arrangements 66, 68, the corresponding backpressure spaces 44a, 44b; 46a, 46b of the two sealing stages 48a, 48b; 50a, 50b are again connected to each other in pairs, which means that the pressure is always equalized. Three pressure-limiting valves 60d, 62d, 64d are also provided, which are designed in this case as proportional valves. Each of these pressure-limiting valves 60d, 62d, 64d has an entrance area 60d1, 62d1, 64d1 and an exit area 60d2, 62d2, and 64d2, and the pressure is reduced between the entrance and exit areas in question in correspondence with the proportionality factor of the associated pressure-limiting valve. The entrance area 60d1 of the first pressure-limiting valve 60d is connected by a connecting line 72 to the first channel area 22 in the first rotary leadthrough element 12 and thus to the source of pressurized fluid. A connecting line 74 connects the exit area 60d2 of the pressure-limiting valve 60d to the entrance area 62d1 of the pressure-limiting valve 62d. In addition, this connecting line 74 is connected by a connecting line 76 to the connecting line arrangement 66.

A connecting line 78 connects the exit area 62d2 of the second pressure-limiting valve 62d to the entrance area 64d1 of the third pressure-limiting valve 64d. In addition, a connecting line 80 connects the connecting line 78 to the connecting line arrangement 68. A connecting line 82 connects the exit area 64d2 of the pressure-limiting valve 64d to the fluid reservoir 58.

In this design variant, therefore, the pressure-limiting valve 60d is basically able to establish a connection between the channel boundary space 28 and the backpressure spaces 44a, 44b of the first sealing stages 48a, 48b. The pressure-limiting valve 62d can establish a fluid connection between the backpressure spaces 44a, 44b of the first sealing stages 48a, 48b and the backpressure spaces 46a, 46b of the second sealing stages 50a, 50b. The pressure-limiting valve 64d can establish a connection between the backpressure spaces 46a, 46d of the second sealing stages 50a, 50b and the fluid reservoir 58.

Because the pressure-limiting valves 60d, 62d, 64d are designed as proportional valves, they do not have a defined switching pressure at which they open to establish a connection between the two spaces in question; rather, they fulfill a pressure-reducing function, according to which the pressure present on the exit side in question corresponds to a certain percentage of the pressure present on the entrance side, namely, to a percentage which corresponds to the proportionality factor of the valve in question.

In the case shown here, in which the three pressure-limiting valves 60d, 62d, 64d again serve the purpose of bridging the sealing elements 32a, 32b; 36a, 36b; 40a, 40b which are parallel to them or which are connected to them in parallel in terms of the pressure relationships, it is possible, by selection of the proportionality factors, to guarantee in addition that a uniform pressure reduction occurs in the direction proceeding away from the chamber boundary space 28 to the backpressure spaces 44a, 44b and then onward to the backpressure spaces 46a, 46b. For this purpose, it is possible, for example, for the first pressure-limiting valve 60d to be designed so that the exit pressure present on the exit side 60d2 is equal to ⅔ of the entrance pressure present at the entrance area 60d1 and therefore also in the first channel area 22. If the entrance pressure is 60 bars, the result is that a pressure of 40 bars will be present on the exit side 60d2 and therefore also in the backpressure spaces 44a, 44b. In the case of this pressure-limiting valve 60d, therefore, a proportionality factor defined by the quotient of the exit pressure over the entrance pressure corresponds to a value of ⅔. To obtain a corresponding pressure step-down at the transition from the first sealing stages 48a, 48b to the second sealing stages 46a, 46b, the second pressure-limiting valve 62d can work with a proportionality factor of approximately 0.5. The pressure of 40 bars then still present in the entrance area 62d1 will therefore be reduced by 50%, so that a pressure of approximately 20 bars will be obtained in the backpressure spaces 46a, 46b of the second sealing stages 50a, 50b. The third pressure-limiting valve 64d can then work with a very small proportionality factor such as 0.1 or even smaller, for example, so that it can be seen overall that the proportionality factors of the pressure-limiting valves decrease in the direction proceeding away from the area 26 adjacent to the channels. It should be pointed out here that, through the appropriate selection of the proportionality factors, it is possible to achieve essentially any desired pressure reduction, which obviously can be selected as a function of the concrete design aspects in question.

In the case of the design variant shown in FIG. 4, it can be seen that the backpressure spaces 46a, 46b of the second sealing stages 50a, 50b can be brought into connection with the fluid reservoir 58 by the connecting line 80 and the pressure-limiting valve 64d. This means that it would be possible here, if desired, to eliminate the fluid discharge spaces 52a, 52b and the discharge channel arrangement 56. Of course, it is still possible in this design variant to include the fluid discharge spaces adjacent to the second sealing stages 50a, 50b to realize complete protection against the escape of fluid.

The essential advantage of a design variant working with these types of proportional valves is that proportionally down-scaled backpressures can be produced in all the sealing stages or involved spaces even at comparatively low pressures. If, for example, in the case of the embodiment according to FIG. 2, the prevailing pressure relationships are such that only the pressure-limiting valves 60a, 60b open or if they are such that even these valves do not open, it is primarily the sealing elements 32a, 32b forming the boundaries of the channel boundary space 28 which will be subjected to load, whereas the other sealing elements, i.e., those farther away from the channel boundary space 28, will be subjected to a much lighter load. This can lead to more pronounced wear on the sealing elements closer to the channel boundary space 28. This problem can be avoided in the case of the embodiment shown in FIG. 4, in which, as a result of the proportional action of the pressure-limiting valves 60d, 62d, 64d, all of the backpressure spaces and therefore all of the sealing elements will always be involved in the cascade effect, even when the prevailing pressures are relatively low.

It should also be pointed out here that the design of these types of proportional valves is so well known in the prior art that there is no need to provide any further explanation of them.

In the case of the embodiments of the rotary leadthrough described above, it is obviously also possible to implement a wide variety of variations. For example, the grooves holding the sealing elements do not necessarily have to be in the radially outer, i.e., the first, rotary leadthrough 12. It is obvious that the grooves holding the sealing elements could also be provided in the second rotary leadthrough 14. It is also possible to fit some of the sealing elements into grooves in one of the rotary leadthrough elements and the remaining sealing elements into grooves in the other rotary leadthrough element. The number of sealing elements and therefore the number of backpressure spaces and sealing stages can also be varied. More than two sealing stages can be provided. It is also possible to provide only a single sealing stage with two sealing elements forming the boundaries of a backpressure space

one of which will obviously in this case be on each axial side of the boundary space 28. The fluid discharge space, for example, can then follow after this single sealing stage. The pressure-limiting valves acting in the direction proceeding away from the channel boundary space can also be designed with different switching characteristics if they do not have proportional switching behavior.

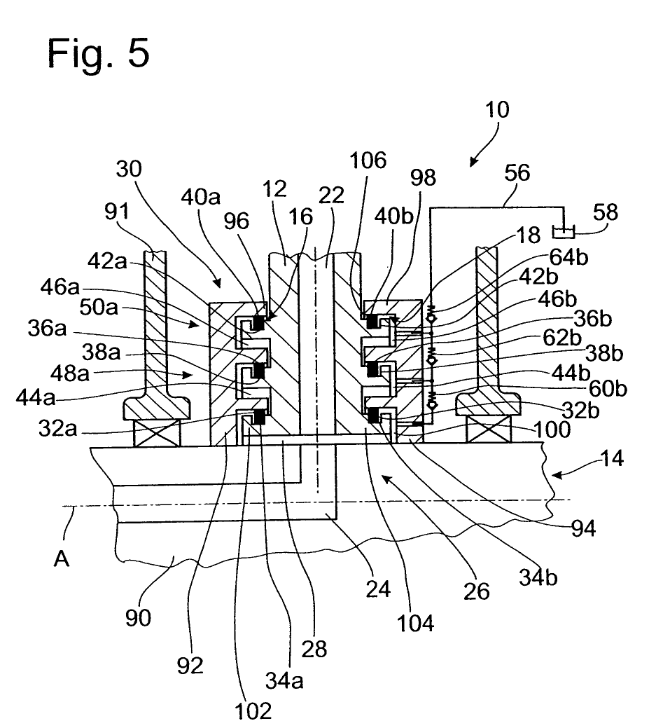

Another example of an inventively designed rotary leadthrough is shown in FIG. 5. In this design variant, the sealing elements 32a, 36a, 40a; 32b, 36b, 40b following each other in the direction proceeding away from the channel boundary space 28 are arranged not in axial sequence but rather in radial sequence, so that the individual sealing stages 48a, 50a; 48b, 50b also follow each other in radial sequence.

It can be seen in FIG. 5 that the second rotary leadthrough element 14, which is usually the rotating element, comprises a radially inner, shaft-like component 90, in which the channel area 24, which leads, for example, to a gas spring torsional vibration damper, is also formed. The shaft-like component 90 can be supported rotatably in a housing 91, illustrated schematically here. Two ring-shaped disk parts 92, 94, opposing each other as mirror images, can be permanently connected by welding, for example, to this shaft-like component 90 in such a way that they hold between them a component, also designed essentially as a ring-shaped disk, which serves as the first rotary leadthrough element 12. The two disk parts 92, 94 have projections 96, 98 extending toward each other in a spaced series, the number of projections corresponding to the number of radially spaced sealing elements. Each of the projections 96, 98, which are essentially cylindrical in shape and which can rotate around the axis of rotation A, has an inside circumferential surface, which provides a section 100 of the second rotary leadthrough element surface 18 of the second rotary leadthrough element 14. It can be seen that the second rotary leadthrough element surface 18 thus comprises here a total of six of these sections 100, which provide the inside circumferential surfaces, three of which are present on each of the disk parts 92, 94 in radially spaced fashion.

On the two opposite axial sides of the nonrotating, first rotary leadthrough element 12, several projections 102, 104 corresponding in number to the number of projections 96, 98, are provided. Each of these cylindrically formed projections 102, 104 extending circumferentially all the way around the axis of rotation A, has an outside circumferential surface, which serves as a section 106 of the first rotary leadthrough element surface 16, which therefore has here the form of an outside circumferential surface or of a plurality of sections of outside circumferential surfaces. One of the grooves 34a, 38a, 42a; 34b, 38b, 42b is provided in each of these sections 106 to hold the sealing elements 32a, 36a, 40a; 32b, 36b, 40b. Thus each of these sealing elements rests between two of the projections 96, 102; 98, 104 on the two rotary leadthrough elements 12, 14 with a sealing action in the manner described above.

A series of two sealing stages 48a, 50a; 48b, 50b is therefore again formed in the direction proceeding away from the channel boundary space 28 on each of the two axial sides of the first rotary leadthrough element 12. In the same way as described above, these sealing stages produce a gradual pressure reduction in the direction proceeding away from the channel boundary space 28.

Because of the chosen design, which is again symmetric to the channel boundary space 28, with two sealing stages on each side forming a sequence in the radial direction, a reliable sealing effect is again obtained on both sides of the area 26 adjacent to the channels.

It should be pointed out here that the design variant illustrated on the left side of the channel boundary space 28 in FIG. 5 corresponds to that shown in FIG. 1, whereas the variant shown on the right side of the channel boundary space 28 corresponds to that shown in FIG. 2, in which the successive backpressure spaces 44b, 46b of the two sealing stages 48b, 50b are connected by the pressure-limiting valves 60b, 62b, 64b, which thus bridge the sealing elements 32b, 36b, 40b forming the boundaries of the associated sealing stages 48b, 50b. It is obvious that, in this embodiment as well, the same designs can be provided on both axial sides of the first rotary leadthrough element 12. That is, as shown in the embodiments of FIGS. 3 and 4, pressure-limiting valves can be provided on both sides; no pressure-limiting valves can be provided on either side; or the backpressure spaces of corresponding sealing stages can be combined into pairs of backpressure spaces and then these pairs can be connected to each other by pressure-limiting valves. It is also obvious that the sealing stages 50a, 50b in last place in the direction proceeding away from the channel boundary space 28 can again be provided with fluid discharge spaces, as previously described with reference to FIG. 1, so that the last pressure-limiting valve 64b (and of course also 64a) can then bridge the last sealing element 40b, 40a before this fluid discharge space, and the fluid discharge space can then be open via the line 56 to the fluid reservoir 58.

In principle, therefore, the same effect can be obtained with the radial spacing of the individual sealing elements of successive sealing stages shown in FIG. 5 as that obtained with the previously described axial spacing. Of course, it is also possible in the case of the embodiment shown in FIG. 5 to arrange the sealing elements of the successive sealing stages with an axial offset from each other.

It is also obvious that the principle of the present invention can also be realized with axially opposing rotary leadthrough elements or rotary leadthrough element surfaces. Here, for example, the area adjacent to the channels can be positioned in the area of the axis of rotation and thus centrally, so that the sealing elements, which then can also have the shape of rings, will be spaced in the radially outward direction and thus produce a sequence of sealing stages proceeding from the radially inner area to the radially outer area. The area adjacent to the channels, however, could also be offset radially outward from the axis of rotation, so that a radial sequence of sealing stages proceeding both radially inward and radially outward can be realized.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A rotary lead-through comprising:
a first rotary lead-through element having a first channel opening on a first boundary surface;
a second rotary lead-through element having a second channel opening on a second boundary surface which is opposite from the first boundary surface and can rotate relative to the first boundary surface about an axis of rotation, the first and second channels being in fluid communication via a channel boundary space, and
a sealing arrangement acting between the first and second lead-through elements, the sealing arrangement comprising at least one sealing stage, each said sealing stage comprising a first sealing element toward the boundary space and a second sealing element away from the boundary space, the first and second sealing elements enclosing a backpressure chamber surrounding the axis of rotation.

2. The rotary lead-through of claim 1 wherein said sealing arrangement comprises a plurality of successive sealing stages including a first sealing stage and a last sealing stage, said sealing stages extending in a direction away from the boundary space, wherein the first sealing element forms the second sealing element of the previous stage and separates two immediately successive said backpressure spaces.

3. The rotary lead-through of claim 1 wherein the first boundary surface is an inside circumferential surface which is concentric to the axis of rotation, and the second boundary surface is an outside circumferential surface which is concentric to the axis of rotation.

4. The rotary lead-through of claim 1 wherein the first and second boundary surfaces are orthogonal to the axis of rotation, and face each other axially.

5. The rotary lead-through of claim 1 wherein said sealing elements are ring-shaped seals, at least one of said first and second lead-through elements having at least one ring shaped channel, each said ring-shaped seal being received in a respective said ring shaped channel and bearing against the opposite boundary surface.

6. The rotary lead-through of claim 2 further comprising at least one pressure-limiting valve connecting two immediately successive backpressure spaces, each said pressure-limiting valve acting in parallel to a respective said sealing element separating said two immediately successive said backpressure spaces.

7. The rotary lead-through of claim 2 wherein said sealing arrangement comprises a plurality of successive sealing stages on either side of said channel boundary space, wherein the backpressure spaces of respective pairs of sealing stages on opposite sides are connected by respective connecting channels.

8. The rotary lead-through of claim 7, further comprising a pressure-limiting valve connecting each said pair of connecting channels.

9. The rotary lead-through of claim 7 wherein said connecting channels are circumferentially offset from each other with respect to said axis of rotation.

10. The rotary lead-through of claim 1 further comprising a pressure-limiting valve connecting the channel boundary space to the backpressure space of the first sealing stage.

11. The rotary lead-through of claim 2 further comprising:
a pressure limiting valve connecting the backpressure space of the last sealing stage to a fluid discharge space; and
a discharge channel which carries fluid away from the fluid discharge arrangement.

12. The rotary lead-through of claim 11 wherein the discharge channel leads to an essentially pressureless fluid reservoir.

13. The rotary lead-through of claim 6 wherein each said pressure-limiting valve limits the pressure difference between immediately successive backpressure spaces to less than a maximum allowable pressure on the sealing element separating said two immediately successive said backpressure spaces.

14. The rotary lead-through of claim 6 wherein each of a plurality of said pressure-limiting valves limits the pressure difference between immediately successive backpressure spaces so that maximum pressure differences which can be generated between backpressure spaces of successive sealing stages are essentially the same.

15. The rotary lead-through of claim 14 wherein the pressure-limiting valves have essentially the same switching pressure.

16. The rotary lead-through of claim 14 wherein the pressure-limiting valves are proportional valves.

17. The rotary lead-through of claim 16 wherein each said proportional valve has a proportionality factor formed by the quotient of the exit pressure divided by the inlet pressure, the proportionality factors of successive proportional valves decreasing in a direction away from the channel boundary space.

18. A rotary lead-through comprising:
a first rotary lead-through element having a first channel opening on a first boundary surface;
a second rotary lead-through element having a second channel opening on a second boundary surface which is concentric to the first boundary surface and can rotate relative to the first boundary surface about an axis of rotation, the first and second channels being in fluid communication via a channel boundary space surrounding the axis of rotation; and
a sealing arrangement acting between the first and second lead-through elements, the sealing arrangement comprising a plurality of successive sealing stages on either side of said channel boundary space, each sealing stage comprising a first sealing element toward the boundary space and a second sealing element away from the boundary space, the first and second sealing elements of each sealing stage enclosing a backpressure chamber surrounding the axis of rotation.
